(19) United States
(12) Patent Application Publication
(10) Pub. No.: US 2006/0256117 A1
(43) Pub. Date: Nov. 16, 2006

(54) Method for the management of descriptions of graphic animations for display, receiver and system for the implementation of said method

(76) Inventor: Cedric Gegout, Rennes (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/546,347

(22) PCT Filed: Feb. 18, 2004
(86) PCT No.: PCT/FR04/00364

§ 371 Date: Jun. 21, 2006

(30) Foreign Application Priority Data
Feb. 21, 2003 (FR) 03/02144

(51) Int. Cl. G06T 15/70

(52) U.S. Cl. 345/473

(57) ABSTRACT

A method of managing descriptions of graphics animations for display. A graphics animation is defined by data defining a spatial-temporal arrangement content of graphics objects to be displayed. For at least one of the graphics objects, the data includes data describing primitives corresponding to the graphics object. The data describing a spatial-temporal arrangement content and the data describing graphics object primitives are stored independently in storage means adapted to be interrogated. A spatial-temporal arrangement content that contains an object for definition by such primitives includes data designating the storage means to be interrogated in order to obtain the data corresponding to said primitives.

### GENERAL TECHNICAL FIELD—PRIOR ART

The present invention relates to graphics animation description techniques.

More particularly, the invention proposes a method of managing graphics scenes, and a storage system and a receiver for implementing the method.

There are at present several graphics animation representation formats.

They use two main approaches:

one is based on a tree-like representation of the spatial-temporal arrangement of graphics objects that enables refined interaction between the graphics objects and sub-objects but necessitates, before display as such, intermediate processing known as “rasterization”;

the other approach is based on a polygonal frame rendition mode and uses simple primitives that ensure rapid rendition.

The first approach corresponds to graphics description formats such as those used by W3C/SVG and MPEG-4/System/BIFS, for example. However, this first approach does not provide optimum graphics rendition. It also induces a calculation overcost for certain animations that would not in themselves necessitate the use of this technique.

The second approach provides efficient rendition of graphics animations; however, it does not make it possible to have refined interaction with the graphics sub-objects constituting the graphics animation and the rendition depends on the display characteristics of the receiver. This second approach corresponds to graphics formats such as Macromedia SWF and the display lists routinely used for 3D display by tools such as OpenInventor, for example.

### GENERAL DESCRIPTION OF THE INVENTION

An object of the invention is to propose a technique that mitigates the drawbacks of current graphics representation techniques, which suffer either from a lack of interactivity or from a lack of graphics rendition efficiency.

To this end the invention provides a method of managing descriptions of graphics animations for display, the method being characterized in that a graphics animation is defined by a set of data describing a spatial-temporal arrangement content of graphics objects to be displayed, and in that, for at least one of said graphics objects, said set of data includes data describing primitives corresponding to said graphics object, the data describing a spatial-temporal arrangement content and the data describing graphics object primitives being stored independently.

It will be noted that the proposed technique, in particular by combining a plurality of vector graphics representation levels, saves memory space by making it possible to use the graphics representation most appropriate to a given animation.

Many graphics representations or animations do not need to be described in the form of a composite of simple vector primitives, but can benefit from a representation in the form of a list of graphics rendition primitives of lower level.

Low-level primitives are of the {action, polygon, duration} type, for example, in which the action is adding, replacing, or destroying a shape described by a polygon with integer non-vector coordinates.

By acting on the various representation modes, this technique has the further advantage of enabling the performance of the graphics rendition engine to be under complete control, in particular through non-systematic use of the spatial-temporal arrangement.

The proposed technique may additionally be easily integrated into most graphics rendition devices capable of rendering vector shapes.

This method advantageously has the following additional features, in isolation or in any technically feasible combination:

the storage means include server means adapted to send data to a remote client, the data describing a spatial-temporal arrangement content of graphics objects to be displayed and/or data describing primitives;

a spatial-temporal arrangement content that contains an object defined by primitives that are stored independently includes data identifying said data and/or the means in which it is stored;

to display a graphics animation, data is received that corresponds to a spatial-temporal arrangement content of graphics objects to be displayed, the data received in this way from said means is decoded and, if the arrangement that corresponds to this data includes a graphics object for definition by primitives that are stored independently, data corresponding to said primitives is received and decoded;

the primitives corresponding to the data received for said graphics object are directly displayed and pre-rendition processing is applied to the spatial-temporal arrangement content prior to display; and

the primitives corresponding to the data received for said graphics object are sent to a stack of rendition primitives with the primitives obtained for the spatial-temporal arrangement content on exiting the pre-rendition processing.

The invention also provides a receiver including display means and means for receiving and decoding data describing a spatial-temporal arrangement content of graphics objects to be displayed, the receiver being characterized in that it includes means for receiving and decoding data stored independently and corresponding to primitives defining at least one graphics object in the spatial-temporal arrangement content for said object, and processor means for processing said data processing to display the spatial-temporal arrangement content and said primitives.

The invention further provides a system for implementing the above-defined method of managing descriptions of graphics animations to be displayed, the system being characterized in that it includes means in which data describing a spatial-temporal arrangement content and data describing graphics object primitives are stored independently.

The invention further provides a signal carrying a set of data defining a spatial-temporal arrangement of graphics objects and sub-objects for display, the signal being characterized in that, for at least one graphics object, said set of data includes data identifying primitives stored independently and/or data identifying the means in which they are stored.

The invention further provides a method of breaking down graphics animation images for display, the method being characterized in that said images are broken down into data describing a spatial-temporal arrangement content of graphics objects to be displayed and, for at least one of the graphics objects, a set of data defining primitives corresponding thereto, the spatial-temporal arrangement content, for said graphics object including data designating the storage means in which the data defining said primitives of said object is stored.

### DESCRIPTION OF THE DRAWINGS

Other features and advantages of the invention emerge from the following illustrative and non-limiting description given with reference to the appended drawings, in which:

FIG. 1 is a diagram representing the reception of an initial scene;

FIG. 2 is a diagram representing the rendition processing effected in the receiver shown in FIG. 1; and

FIG. 3 is a diagram showing the encoding of an image.

### DESCRIPTION OF ONE OR MORE EMBODIMENTS OR IMPLEMENTATIONS

FIG. 1 shows a receiver R, for example a mobile telephone, which communicates with at least two external data sources (servers A and B), from which it receives streams of binary data describing graphics objects and scenes to be displayed by said receiver R.

The graphics animations are loaded in the following manner:

The receiver R requests a graphics animation content from the source constituted by server A.

That server A sends said receiver R a content S (the graphics scene) which describes the spatial-temporal arrangement of the graphics objects.

This is shown by arrows 1 and 2, which symbolize a content request sent by the receiver R to the source A and the sending of that content to the receiver R by said source A.

When the graphics scene that is described contains a composite graphics object OC, the receiver R interrogates the server B that is designated, in the information that said receiver R has just received from the server A, as being the particular server from which the graphics primitives P that correspond to the composite object OC in question are to be obtained.

Those graphics primitives are advantageously low-level graphics primitives of the “actions, polygons, duration” type.

Arrows 3 and 4 in FIG. 1 represent the request for transmission of the graphics primitives sent by the receiver R to the server B, and the transmission of those primitives by the server B to said receiver R.

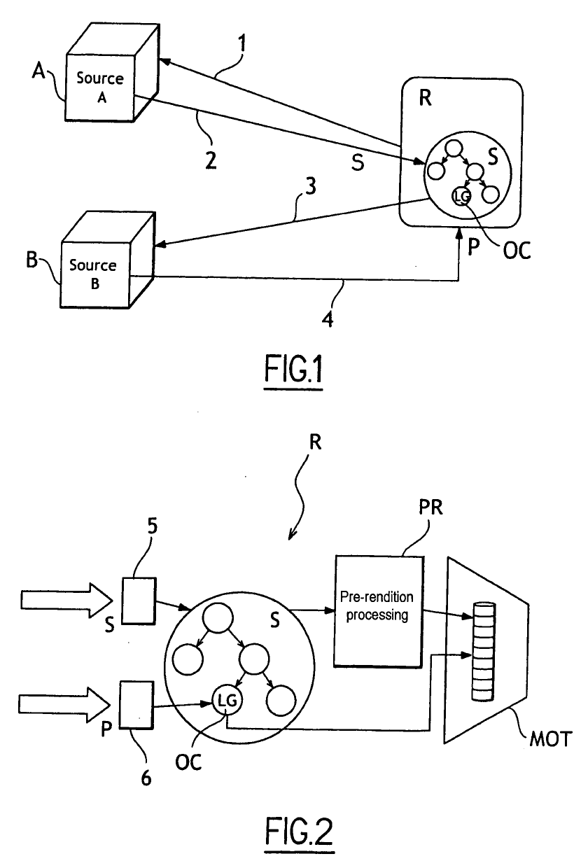

Reference is now made to FIG. 2, which shows the rendition processing that is effected in the receiver R.

As is clear from this figure, the receiver R includes means 5 for decoding the initial scene S and means 6 for decoding the primitives P that are sent to it by the server B that it is interrogating.

The receiver R further includes a processor module MT that comprises a pre-rendition module PR and a rendition engine MOT.

The pre-rendition module PR receives data that corresponds to the image of the scene S and applies pre-rendition processing to it to convert it into rendition primitives, for example of the OpenGL type.

One function of the pre-rendition module PR is to adapt a common graphical representation to the specific device on which it is to be displayed.

In particular, the module PR determines from this common graphics representation the precise coordinates of the objects to be displayed on the screen. It defines in particular the coordinates of the center of the image, the coordinates of the x and y axes, the dimensions of the rendition area, etc.

For examples of pre-rendition processing, reference can advantageously be made to the following documents, for example:

Computer Graphics—Principles and Practice—Foley —Van Dam—Feiner—Hugues—Object Hierarchy and Simple PHIGS—Geometric modeling pp. 286 to 302.

La realisation de logiciels graphiques interactifs—Collection de la Direction des Etudes et Recherches d'EDF; Travaux dirigés de l'Ecole d'été d'informatique du 7 au 27 juillet 1979; pp. 15 to 23. [The production of interactive graphical software—EDF research department collection; Directed work at the data processing summer school of 7 to 27 Jul. 1979].

After the pre-rendition processing, the primitives obtained are stored in a stack of primitives that is processed by the graphics rendition engine MOT.

The role of the rendition engine MOT is to control the display of the objects using the position and dimension elements determined by the pre-rendition module PR.

For example, the graphics objects for which the rendition engine MOT controls display are coded in a format similar to that described in the document:

“ISO/IEC 14496-1: 2002—Information technology—Coding of audio-visual objects, Part 1: Systems” in which reference can be made in particular to the passage describing the 2D layer and the transformation nodes, it being equally possible to use the invention for 3D scenes, of course.

The display control processing effected by the rendition engine MOT serves in particular to manage display conflicts between different objects and is, for example, of the type described in the document:

“ISO/IEC 14772-1: 1998—Information technology—Computer graphics and image processing—The Virtual Reality Modeling Language”

When the processor module MT is to prepare the composite graphics object OC, the primitives P that correspond thereto are sent directly to the processing stack of the rendition engine, without pre-rendition processing.

Those primitives can be displayed directly on the screen, without requiring pre-rendition processing and in particular without requiring adaptation of dimensions.

Accordingly, the rendition of the LowGraphics object is effected by direct display on the screen of the graphics primitives received by the server B.

For example, the engine MOT processes the stack of primitives consisting of the stack of primitives resulting both from the pre-rendition processing and from the primitives received by the receiver for the composite graphics object or objects, this processing being, for example, of the type described in the following publications:
Computer Graphics Principles and Practice by J. D. Foley, A. van Dam, S. Feiner and J. F. Hughes (Addison-Wesley, 1990)
OpenGL Programming Guide by Mason Woo, Jackie Neider and Tom Davis (Addison-Wesley, 1997)
The Inventor Mentor by Josie Wemecke (Addison—Wesley, 1994)

Two programming examples for the same graphics object follow: the first example corresponds to a standard representation of the object; the second example corresponds to a composite representation, combining a standard representation and a representation with low-level primitives.

Standard Representation

```
Transform { children [
        Shape{
            geometry IndexedLineSet {
                point [0100, 000, 2000, −150.2150]
                colorindex [ 0 1 2 −1 # axes 34] # centerline
                color Color { color [ 0 0 0,.2.2.2 ]}
                colorindex [ 0 1 ] # black for axes, gray for
centerline
                colorPerVertex FALSE # color per polyline
          }
      }
        Shape{
            geometry IndexedLineSet {
                point [210, 520, 81.50, 1190, 1470, 17100 ]
                coordIndex [ 0 1 2 3 4 5 ] # connect the dots
                color Color { color [.1.1.1,.2.2.2,.15.15.15,
                      .9.9.9,.7.7.7,111 ]}
      }
      ]}
```

Composite Representation

```
      Transform { children [
        Shape{
            geometry IndexedLineSet {
                point [0100, 000, 2000, −150.2150]
                coordIndex [01 2−1 # axes 34] # centerline
                color Color { color [ 0 0 0,.2.2.2 ]}
                colorindex [01] # black for axes, gray for
                      centerline
                colorPerVertex FALSE # color per polyline
          }
      }
            LowGraphics {
                startTime 10.8// Object 1 will be
displayed in 10.8 seconds
Source “ http://www.myserver.com/LowGraphics ”
        ]}
```

Clearly, in the composite representation, the program calls up the primitives of an object called “LowGraphics” from a server at the following address: “http://www.myserver.com/LowGraphics”

In the composite representation, attributes of the object “LowGraphics” are used to describe the manner in which said object may be processed and composed.

Thus the example given above proposes using an attribute “startTime” to act, after a particular time, to command the triggering of the display of the primitives corresponding to the data received for the object “LowGraphics”.

The above example indicates in particular that the object “LowGraphics” is to be processed after the duration of the graphics scene has passed 10.8 seconds.

In particular, this information enables the receiver to prepare the downloading and, where applicable, the decoding of the signal describing the object in question (the arrows 3 and 4 in FIG. 1 respectively represent the request to send the primitives described in the LowGraphics object and the sending of those primitives).

Other attributes may be used, including in particular:

the “endTime” attribute for stopping the display of the object at a given time;

the “active” attribute for specifying if the object must be displayed or hidden;

the “transparency” attribute for specifying a transparency coefficient to be applied to the object in order to render it more or less transparent vis a vis other graphics objects;

the time to load (TTL) attribute for use when the signal of the “LowGraphics” graphics object specifies a creation date DC of the object and the receiver downloads the object at a downloading date DT, to indicate that the object is not to be displayed if the time (DT-DC) that has elapsed between the creation and the downloading of the object is greater than a given time TTL; and

the “clipping” attribute for supplying the dimensions (width, height) of the area in which the object is to be rendered. If the size of the object is greater than that of said area, it is possible in particular to avoid displaying anything that lies outside that area.

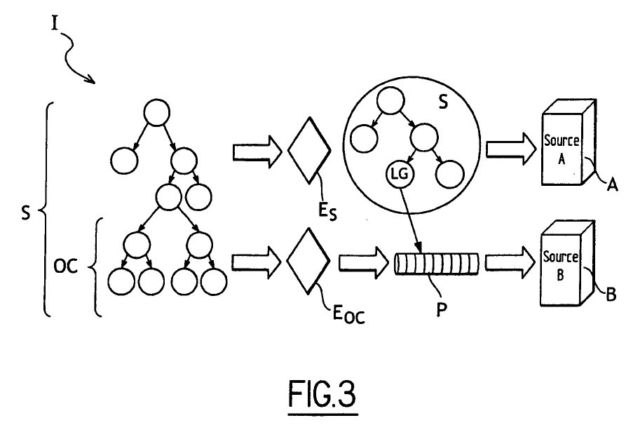

Reference is now made to FIG. 3, which shows the processing for breaking down an image with a view to using different servers for storing the elements that make up the image.

The initial image is broken down into a spatial-temporal arrangement of graphics objects and sub-objects.

Some of these graphics objects can be represented in the form of low-level primitives, for example primitives of the {action, polygon, duration} type.

These composite objects (OC) are encoded (step Eoc) to be stored in the source B in the form of rendition primitives P.

The remainder of the scene, and in particular the other graphics objects, and the general spatial-temporal arrangement of the graphics objects of the scene are encoded in the standard way (step Eₛ) and stored in the source A.

Examples of graphics primitives are described below.

A graphics object is generally represented by a polygonal shape.

Graphics primitives can describe polygons in the form of lists of points (the vertices of the polygon), where applicable associated with colors and textures.

Alternatively, the primitives may define the objects on the basis solely of triangular or trapezoidal shapes.

The primitives then provide only the definitions of the triangles or trapeziums, and where applicable the associated colors and textures.

The program below is one example of low-level primitive encoding for a dodecahedron with 12 faces, each with five vertices.

```
#VRML V2.0 utf8
Viewpoint { description “Initial view” position 0 0 9}
# A dodecahedron: 20 vertices, 12 faces.
# 6 colors (primaries: RGB and complements: CMY) mapped
to the faces.
Transform {
Translation −1.5 0 0
Children Shape {
appearance DEF A Appearance { material Material { } }
geometry DEF IFS
IndexedFaceSet {
coord Coordinate {
point [ # Coords/indices derived from “Jim Blinn's
Corner”
111,11 −1, 1 −11, 1 −1 −1,
−111, −11 −1, −1 −11, −1 −1 −1,
.6181.6180, −.6181.6180, .618−1.618 0, −.618 01.6180,
1.6180.618, 1.6180 −.618, −1.6180.618, −1.6180 −.618,
0.6181.618,0 −.6181.618, 0.618 −1.618, 0 −.618 −1.618
}
coordIndex [
1801213-1, 4951514-1, 21031312-1, 71161415-1, 21201617-1,
11331918-1, 41461716-1, 71551819-1, 416089-1, 21761110-1,
118598-1, 71931011-1,
color Color { # Six colors:
color [001, 010, 011, 100, 101, 110]
}
colorPerVertex FALSE # Applied to faces, not vertices #
This indexing gives a nice symmetric appearance:
colorindex [0, 1, 1, 0, 2, 3, 3, 2, 4, 5, 5, 4 ]
# Five texture coordinates, for the five vertices on each
face. # These will be re-used by indexing into them
appropriately. texCoord
TextureCoordinate {
      Point [# These are the coordinates of a regular
pentagon:
      0.6545080.0244717, 0.09549150.206107
      0.09549150.793893, 0.6545080.975528, 1 0.5,
# And this particular indexing makes a nice image:
texCoordIndex [
01234-1, 23401-1, 40123-1, 12340-1,
23401-1, 01234-1, 12340-1, 40123-1,
4012301, 12340-1, 01234-1, 23401-1
```

In MPEG-4/BIFS (ISO/14496-1), the size of the content of a dodecahedron of this kind is 1050 bytes. Each face can be broken down into three triangles and each triangle comprises three points with coordinates (X, Y).

After compilation, it is therefore necessary to send 12*3*3*2 integers that correspond to the vertices of the triangles (the rendition of a triangle is a basic primitive in OpenGL).

For mobile telephone screens, a pixel (X, Y) can be coded on 2 bytes (maximum screen size 255*255).

This makes 12*3*3*2=216 bytes.

The color component (3 bytes) of each point must be added, which makes 12*3*3*3=324 bytes, i.e. a total of 540 bytes.

It is consequently clear that the proposed processing achieves a significant saving in memory size.

It is to be noted that the techniques described above apply very generally to practically all current graphics animation descriptions: MPEG-4/BIFS, SVG, etc.

It will be noted that the above description relates to the situation in which the animation data (spatial-temporal arrangement content, primitives) is stored in servers interrogated remotely.

Other storage means could be used, of course (for example CD-ROM).

Equally, instead of being interrogated and using a “pull” technology, the servers could send the data to the client using a “push” technology.

1. A method of managing descriptions of graphics animations for display, the method being characterized in that a graphics animation is defined by a set of data describing a spatial-temporal arrangement content of graphics objects to be displayed, and in that, for at least one of said graphics objects, said set of data includes data describing primitives corresponding to said graphics object, the data describing a spatial-temporal arrangement content and the data describing graphics object primitives being stored independently.

2. A method according to claim 1, characterized in that the storage means include server means adapted to send data to a remote client, the data describing a spatial-temporal arrangement content of graphics objects to be displayed and/or data describing primitives.

3. A method according to claim 1, characterized in that a spatial-temporal arrangement content that contains an object defined by primitives that are stored independently includes data identifying said data and/or the means in which it is stored.

4. A method according to claim 1, characterized in that said primitives are of the {action, polygon, duration} type.

5. A method according to claim 1, characterized in that, to display a graphics animation, data is received that corresponds to a spatial-temporal arrangement content of graphics objects to be displayed, the data received in this way from said means is decoded and, if the arrangement that corresponds to this data includes a graphics object for definition by primitives that are stored independently, data corresponding to said primitives is received and decoded.

6. A method according to claim 5, characterized in that the primitives corresponding to the data received for said graphics object are directly displayed and in that pre-rendition processing is applied to the spatial-temporal arrangement content prior to display.

7. A method according to claim 6, characterized in that the primitives corresponding to the data received for said graphics object are sent to a stack of rendition primitives with the primitives obtained for the spatial-temporal arrangement content on exiting the pre-rendition processing.

8. A receiver including display means and means for receiving and decoding data describing a spatial-temporal arrangement content of graphics objects to be displayed, the receiver being characterized in that it includes means for receiving and decoding data stored independently and corresponding to primitives defining at least one graphics object in the spatial-temporal arrangement content for said object, and processor means for processing said data to display the spatial-temporal arrangement content and said primitives.

9. A receiver according to claim 8, characterized in that the processor means display directly the primitives corresponding to the data received for said graphics object and apply positioning and/or dimensioning pre-rendition processing to the remainder of the spatial-temporal arrangement content prior to display.

10. A receiver according to claim 9, characterized in that said processor means include a stack of primitives and a rendition engine that controls and manages the display of the graphics objects stored in said stack, the primitives corresponding to the data received for said graphics object being sent to a stack of rendition primitives together with the spatial-temporal arrangement content primitives obtained on exiting the pre-rendition processing.

11. A receiver according to claim 10, characterized in that said rendition engine uses a display triggering command to act after a particular time to trigger display of the primitives corresponding to the data received for said graphics object.

12. A system for implementing the method of managing descriptions of graphics animations to be displayed according to claim 1, the system being characterized in that it includes means in which data describing a spatial-temporal arrangement content and data describing graphics object primitives are stored independently.

13. A signal carrying a set of data defining a spatial-temporal arrangement of graphics objects and sub-objects for display, the signal being characterized in that, for at least one graphics object, said set of data includes data identifying primitives stored independently and/or data identifying the means in which they are stored.

14. A method of breaking down graphics animation images for display, the method being characterized in that said images are broken down into data describing a spatial-temporal arrangement content of graphics objects to be displayed and, for at least one of the graphics objects, set of data defining primitives corresponding thereto, the spatial-temporal arrangement content, for said graphics object including data designating the storage means in which the data defining said primitives of said object is stored.

15. A method according to claim 14, characterized in that the data that defines the primitives includes coordinates of points that together define one or more polygons.

16. A method according to claim 14, characterized in that the data that defines primitives includes data that defines one or more triangular and/or trapezoidal shapes.

17. A method according to claim 15, characterized in that said data further includes data characterizing colors and/or textures.
